(19) United States
(12) Patent Application Publication
(10) Pub. No.: US 2004/0261461 A1
(43) Pub. Date: Dec. 30, 2004

(54) Method for fabricating optical fiber preform without hydroxyl group in core

(76) Inventors: Chan-Joo Lee, Seoul (KR); Lae-Hyuk Park, Seoul (KR); Jae-Sun Kim, Seoul (KR); Soon-Il Son, Gyeonggi-do (KR)

Correspondence Address: JONES DAY, 222 EAST 41ST ST, NEW YORK, NY, 10017, US

(21) Appl. No.: 10/489,436

(22) PCT Filed: Jun. 26, 2003
(86) PCT No.: PCT/KR03/01251

(30) Foreign Application Priority Data
Jun. 29, 2002 (KR) 10-2002-0037360

(51) Int. Cl. C03B 37/018

(52) U.S. Cl. 65/419; 65/417

(57) ABSTRACT

Method for fabricating an optical fiber preform substantially without hydroxyl group in core includes forming clad layer having relatively low refractive index by depositing soot (SiO₂, GeO₂) to inner surface of quartz tube; and forming core layer having relatively high refractive index on clad layer, which includes (a) a base core layer forming step composed of generating soot by heating inside of quartz tube to 1000° C.-1400° C. with introducing reaction gases (SiCl₄GeCl₄) into quartz tube, accumulating soot on clad layer removing hydroxyl-groups (OH) and moisture from soot and tube by heating inside of quartz tube to 600° C.-1200° C. with introducing dehydration gases (He, Cl₂; O₂) into quartz tube, and sintering and vitrifying soot by heating quartz tube inside over 1700° C. with introducing dehydration gas (He, Cl₂, O₂); and (b) a step of forming at least one additional core layer on base core layer by repeating the accumulating/dehydrating/sintering of the step (a) at least one time.

### TECHNICAL FIELD

The present invention relates to a method for fabricating an optical fiber preform substantially without a hydroxyl group (OH) in a core layer by using a Modified Chemical Vapor Deposition (MCVD).

### BACKGROUND ART

The Modified Chemical Vapor Deposition (MCVD) is one of optical fiber manufacturing methods. In the MCVD, a clad layer is firstly formed, and then a core layer is formed inside the clad layer.

To describe the conventional MCVD in more detail with reference to FIG. 1, a quartz tube 1 is put on lathe, and then reaction gases for forming soot such as SiCl₄, GeCl₄ and POCl₃ are flowed into the quartz tube 1 together with oxygen gas while rotating the quartz tube 1. At the same time, a torch 2 providing a temperature more than 1600° C. is reciprocated out of the tube 1 along the axial direction of the tube 1 so that the reaction gases flowed into the tube 1 are sufficiently reacted.

Whenever the torch 2 reciprocates once, the oxidization reaction of halide gas as expressed in the following Reaction Formula 1 is induced at an area in the tube 1 which reaches a reaction temperature, thereby generating fine glass particles (hereinafter, referred to as ‘soot’) 3. During the movement of the torch 2, the soot 3 is deposited on an inner surface of the tube 1 at an area which has a relatively lower temperature than an area heated by the torch 2, by means of the thermophoresis.

SiCl₄+O₂→SiO₂+2Cl₂ Reaction Formula 1

GeCl₄+O₂→GeO₂+2Cl₂

The layer of soot 3 deposited on the inner surface of the tube 1 is sintered by the heat of the torch 2 adjacently followed and becomes a transparent glass layer. This process is continuously repeated so that there are deposited a plurality of the clad layers on the inner side of the tube 1 and subsequently a plurality of core layers on the clad layer. FIG. 2 shows a section of the optical fiber preform manufactured by the above-mentioned process. In FIG. 2, reference numeral 5 denotes a core, 6 denotes a clad, 7 denotes a tube, 8 denotes a diameter of the core, and 9 denotes a diameter of the clad.

However, in the conventional MCVD, while a plurality of clad layers and core layers are formed, there occurs a problem that hydroxyl groups (OH) are included therein as impurities. In fact, the reaction gases flowed into the tube 1 generally contain a small amount of moisture, and this moisture is absorbed on the surface of the deposition layer formed inside the tube 1 and then dispersed into the deposition layer under the high temperature, thereby generating bond of Si and OH. FIG. 3 shows an interatomic bond structure after the soot deposition layer is sintered in the optical fiber preform fabricating process using MCVD. Referring to FIG. 3, it may be found that a large amount of hydroxyl groups (OH) and Si is bonded therein.

However, since the depositing and sintering of the soot 3 is achieved through successive procedures by using the torch 2 in the MCVD according to the prior art, the removal of the hydroxyl group (OH) included in the clad layer or the core layer as impurities is nearly impossible if any separate dehydration is not conducted. It is because the hydroxyl group (OH) included as impurities in the soot 3 through chemical reaction is stably bonded to Si and stays therein though the MCVD process is conducted at high temperature.

On the other hand, the optical loss, which is most essential for the optical fiber, is composed of the Rayleigh scattering loss caused by the difference of density and constitution of the optical fiber preform, the ultraviolet absorption loss according to electronic transition energy absorption in atom level, the infrared absorption loss according to energy absorption during lattice vibration, the hydroxyl group absorption loss due to vibration of hydroxyl group (OH), and the macroscopic bending loss.

The optical loss should be low in order to ensure reliable signal transmission through the optical fiber. The optical fiber generally has an optical loss lower than a predetermined level in the wavelength range between 1280 nm and 1620 nm, and currently two wavelengths 1310 nm and 1550 nm are used as main wavelength ranges for optical communication. In addition, the optical loss due to the hydroxyl group (OH) absorption is particularly considered significant in the wavelength 1385 nm more than in other wavelengths, and this wavelength is at present not used due to the high optical loss caused by the hydroxyl group (OH) absorption. Thus, in order to use all of the wavelength range 1310 nm-1550 nm, the average optical loss in the wavelength 1385 nm due to the hydroxyl group (OH) in the optical fiber should be lower than a value at 1310 nm (average 0.34 dB/Km). Since the core composed of germanium dioxide and silicon dioxide has a Rayleigh loss of about 0.28 dB/Km caused by the density and constitution difference of its material itself, the optical fiber can be used in the wavelength 1310 nm-1550 nm only when the optical loss caused by the hydroxyl group (OH) is controlled lower than at least 0.06 dB/Km. For this reason, the fabrication of the optical fiber preform should be also controlled so that the concentration, of hydroxyl group (OH) in the optical fiber is not more than 1 ppb. However, the concentration of hydroxyl group comes up to 30 ppm when only two hydroxyl groups exist on the surface of particle having a diameter of 1 μm, and this concentration may be converted into an optical loss of even 0.75 dB/Km. This fact shows that the MCVD according to the prior art may hardly control the concentration of hydroxyl group (OH) contained in the optical fiber preform as impurities in the level of not more than 1 ppb.

It is known that an OH-free single mode optical fiber may be fabricated by using OVD (Outside Vapor Deposition) as disclosed in U.S. Pat. Nos. 3,737,292, 3,823,995 and 3,884,550, and using VAD (Vapor Axial Deposition) as disclosed in U.S. Pat. Nos. 4,737,179 and 6,131,415.

However, different to OVD and VAD, the conventional MCVD executes the deposition process and the sintering process at the same time so that the soot is formed and at the nearly same time melted and condensed. Thus, in the optical fiber preform fabricated by the conventional MCVD, Si—OH is included in the glass layer condensed due to the sintering causes critical hydroxyl group (OH) absorption loss at the wavelength 1385 nm. Accordingly, the optical fiber drawn from the preform fabricated by the conventional MCVD has a limitation in the usable optical communication wavelength range

Japanese Laid-open Patent Showa 63-315530 discloses a method for making an optical fiber preform, which includes the steps of forming a porous accumulation layer by accumulating metal oxide particles; dehydrating the porous accumulation layer by flowing a dehydrating agent into a quartz tube having the porous accumulation layer; sintering the porous accumulation layer to be transparent while flowing the dehydrating agent into the quartz tube; and condensing the quartz tube with the dehydrating agent being filled in the quartz tube.

This patent is however difficult to completely remove all hydroxyl groups (OH) existing in the deposition layer if the deposition layer (particularly, the core layer) is thick since the dehydration is conducted after the clad layer and the core layer are all accumulated in the quartz tube.

In other words, the technique suggested by Japanese Laid-open Patent Showa 63-315530 is not suitable for making an optical communication system at present (particularly, CWDM) in which the optical fiber preform is large-sized and the minimum absorption loss is required at 1385 nm.

### DISCLOSURE OF INVENTION

In order to solve the problem that the removing efficiency of hydroxyl groups (OH) existing in the core layer is low since the dehydration is not sufficiently progressed deep into the deposition layer in which a thick clad or core layer is deposited, which occurs when fabricating an optical fiber preform by use of MCVD according to the method disclosed in Japanese Laid-open Patent Showa 63-315530, the inventors found out that the hydroxyl groups (OH) in the core layer may be substantially completely removed by means of depositing at least one core layer on the inside of the quartz tube and then independently conducting the dehydration process whenever each core layer is deposited.

Thus, in the method for fabricating an optical fiber preform using MCVD, the present invention is directed to an object to provide an optical fiber preform fabricating method which may substantially remove all hydroxyl groups (OH) existing in the core layer regardless of the thickness of the deposition layer in the quartz tube.

In addition, another object of the invention is to provide a method for fabricating an optical fiber, which may be used for optical communication in the entire wavelength range of 1310 nm˜1550 nm, by use of the OH-free optical fiber preform.

In this aspect, the present invention is substantially related to a method for fabricating an optical fiber preform in which hydroxyl groups (OH) are removed from the core layer.

In more detail, the present invention provides a method for fabricating an optical fiber preform substantially without hydroxyl group (OH) in a core layer by use of MCVD (Modified Chemical Vapor Deposition), which includes the steps of: (1) forming a clad layer with a relatively low refractive index by depositing soot containing SiO₂ and GeO₂ on an inner surface of a quartz tube; and (2) forming a core layer with a relative high refractive index on the clad layer, wherein the core layer forming step includes: (a) a base core layer forming step having an accumulation process for generating soot by heating the quartz tube so that a temperature in the quartz tube becomes 1000° C.˜1400° C. while introducing a reaction gas for forming soot together with a carrier gas, and then accumulating the soot on the clad layer, a dehydration process for removing hydroxyl group (OH) and moisture contained in the soot and the tube by heating the quartz tube so that a temperature in the quartz tube becomes 600° C.˜1200° C. while introducing a dehydration gas into the quartz tube, and a sintering process for sintering and vitrifying the soot by heating the quartz tube to which the soot is deposited so that a temperature in the quartz tube becomes over 1700° C.; and (b) an additional core layer forming step for additionally forming at least one core layer on the base core layer by repeating the accumulation, dehydration and sintering processes of the step (a) at least one time.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is for illustrating a method for fabricating an optical fiber preform using MCVD according to the prior art;

FIG. 2 is a sectional view showing an optical fiber preform fabricated by the method of FIG. 1;

FIG. 3 shows that moisture is absorbed into the soot deposited by the method of FIG. 1;

FIG. 4 is for illustrating the clad layer forming process according to a preferred embodiment of the present invention;

FIGS. 5a to 5f are for illustrating the core layer forming process according to a preferred embodiment of the present invention;

FIG. 6 is a sectional view showing a hollow preform in which a clad layer and a core layer are deposited on the inside of a quartz tube according to a preferred embodiment of the present invention; and

FIG. 7 is a graph showing the absorption loss of the optical fiber core layer according to the wavelength for comparing the present invention with the prior art.

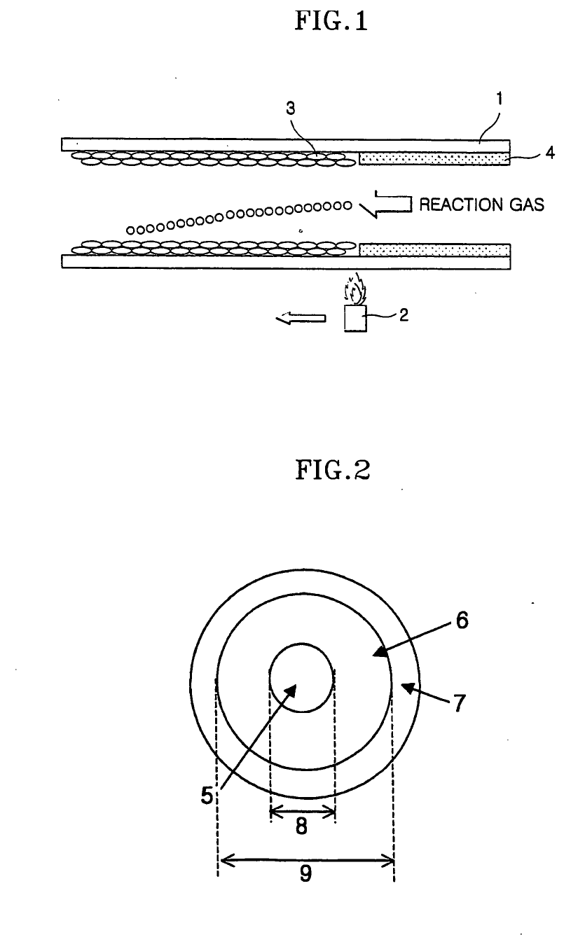

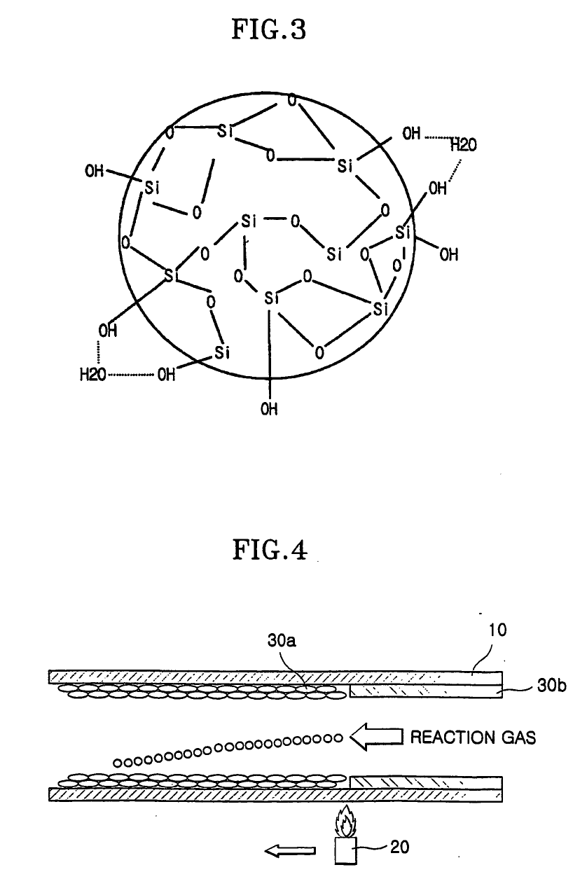

### BEST MODES FOR CARRYING OUT THE INVENTION

Hereinafter, preferred embodiments of the present invention will be described in detail with reference to the accompanying drawings.

A method for fabricating an optical fiber preform according to the present invention is composed of a clad layer forming step and a core layer forming step.

The clad layer forming step is also composed of a deposition step of the clad layer and a sintering step of the clad layer. In addition, the core layer forming step is also composed of a base core layer accumulation step, a base core layer dehydration step, a base core layer sintering step and a step of additionally forming at least one core layer on the base core layer.

Now, the method for fabricating an optical fiber preform according to the present invention is described in detail with reference to FIGS. 4 to 6.

1. Step of Forming Clad Layer

At first, FIG. 4 is showing a soot deposition process.

While a quartz tube 10 having a concentration of hydroxyl group (OH) less than 500 ppb is rotated, gases in which reaction gases for forming soot such as SiCl₄, GeCl₄ and POCl₃ are mixed with oxygen gas are blown into the tube. While blowing the mixed gases into the tube, the tube is heated by use of a heat source 20 so that a temperature in the tube becomes over 1700° C.

The reaction gases introduced in an arrowed direction of FIG. 4 are oxidized due to the heat conducted from the surface of the quartz tube 10 to generate soot 30a. The soot 30a is moved in the tube toward an area having a relatively lower temperature and then accumulated on the inner surface of the tube by means of thermophoresis.

At least one layer of clad soot particle 30a is accumulated on the inner surface of the quartz tube 10. In addition, as shown in FIG. 4, the heat source 20 is moved to the arrowed direction of FIG. 4, and the soot 30a accumulated on the inner surface of the tube is thereby sintered and vitrified after the accumulation process in order to form a sintered layer 30b.

The above-mentioned accumulation and sintering processes form one clad layer, and these processes are repeated until the clad layer obtains a desired thickness.

At this time, the quartz tube 10 preferably rotates at a rotation speed of 20 rpm˜100 rpm. If the rotation speed of the quartz tube 10 is not more than 20 rpm, the soot is not accumulated in a uniform thickness. In addition, if the rotation speed of the quartz tube 10 is not less than 100 rpm, the accumulation speed of soot is lowered.

The heat source 20 also preferably moves at a velocity less than 500 mm/min along the longitudinal direction of the quartz tube 10 (see an arrow of the heat source 20 in FIG. 4). If the velocity of the heat source 20 is over 500 mm/min, the particles deposited on the inner surface of the tube are not uniformly sintered to cause distortion of the deposited surface.

2. Step of Forming Core Layer

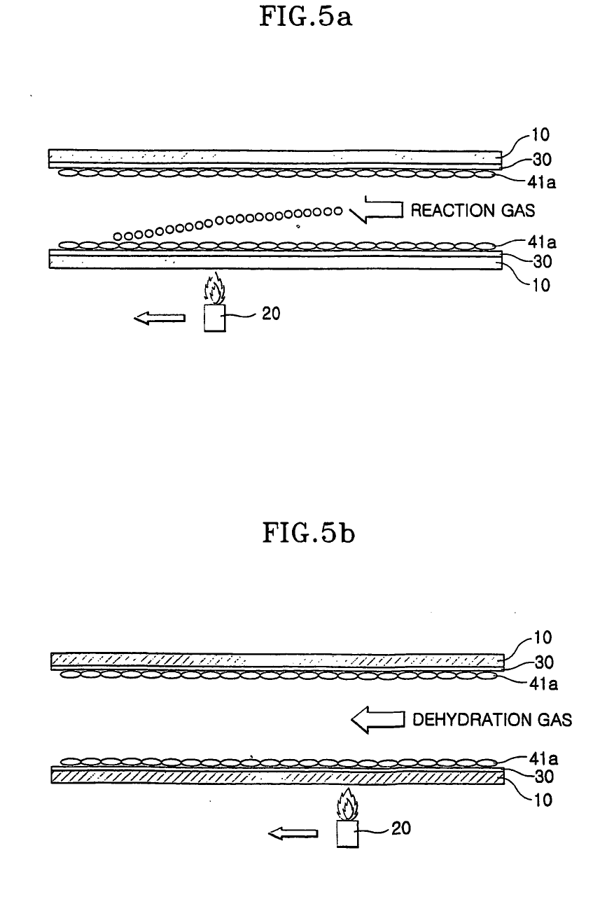

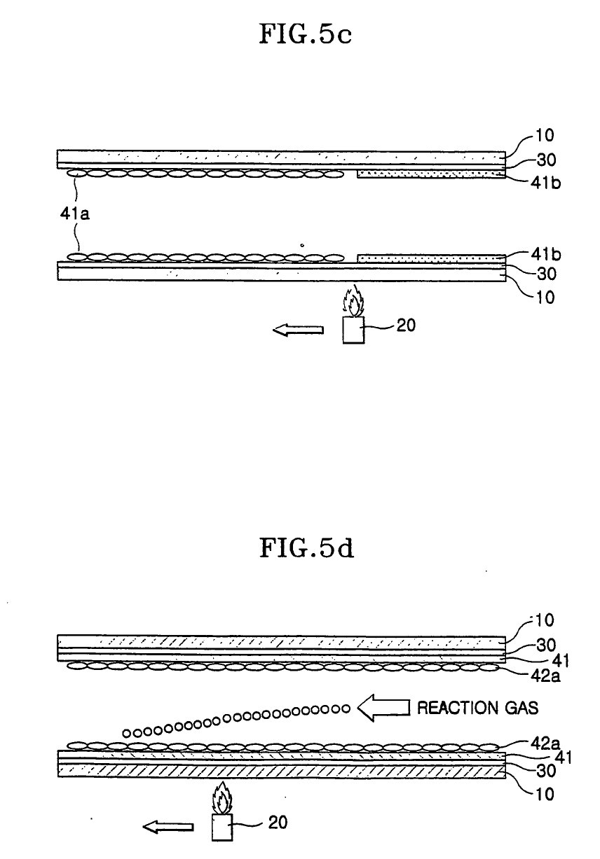

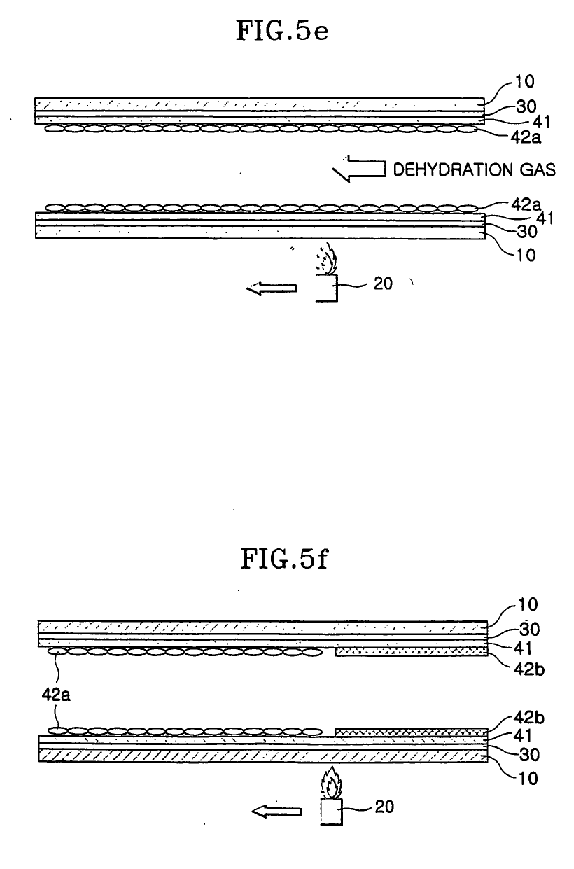

Now, the step of forming a core layer according to the present invention is described in detail with reference to FIGS. 5a to 5f.

(1) Forming a Base Core Layer

While blowing the mixed gases in which reaction gases for forming soot such as SiCl₄ and GeCl₄ are mixed with oxygen gas into the quartz tube 10 on which the clad layer 30 is formed, the tube is heated by use of the heat source 20 so that a temperature in the tube becomes in a range of 1000° C.˜1400° C.

At this time, the heat source 20 preferably moves at a velocity less than 500 mm/min along the longitudinal direction of the quartz tube 10 (see an arrow of the heat source 20 in FIG. 5a). If the velocity of the heat source 20 is over 500 mm/min, the oxygen gas and the reaction gas introduced into the tube may be not sufficiently reacted, thereby insufficiently generating SiO₂ and GeO₂ to form a deposition layer.

The reaction gas introduced in the arrowed direction of FIG. 5a is oxidized by means of the heat conducted from the surface of the quartz tube 10 to generate soot 41a. This soot 41a then moves to an area having a relatively lower temperature in the tube and is then accumulated on the clad layer 30 by means of the thermophoresis.

At this time, the quartz tube 10 preferably rotates at a rotation speed of 20 rpm˜100 rpm. If the rotation speed of the quartz tube 10 is not more than 20 rpm, the soot is not accumulated in a uniform thickness. In addition, if the rotation speed of the quartz tube 10 is not less than 100 rpm, the accumulation speed of soot is lowered.

After forming a base core layer 41 of the soot 41a on the inner surface of the quartz tube 10, the dehydration process is proceeded as shown in FIG. 5b.

While dehydration gases including helium (He), chlorine (Cl₂) and oxygen (O₂) is blown into the quartz tube 10 in which the soot 41a is accumulated, the heat source 20 heats the tube 10 with moving along the direction to which the dehydration gases is blown.

At this time, a temperature in the quartz tube 10 is preferably kept to 600° C.˜1200° C. If the temperature in the tube 10 becomes over 1200° C., the soot forms a neck with the number of soot particles decreasing due to the aggregation of the soot particles. As a result, the diameter of the soot particle is increased and the pores existing among the soot particles, which are dispersion route of the hydroxyl groups (OH), are disappeared more rapidly than the case that the temperature in the quartz tube 10 is kept to 600° C.˜1200° C. In other words, since the soot is grown at a rate faster than the rate that the hydroxyl groups (OH) existing in the pores are dispersed, the hydroxyl groups (OH) are not dispersed out of the soot 41a but captured therein.

Thus, in order to efficiently evaporate the hydroxyl groups (OH) and moisture included in the soot 41a, the clad layer 30 or the quartz tube 10 and also prevent the hydroxyl groups (OH) from being captured therein, the temperature for the dehydration is preferably kept between 600° C.˜1200° C.

In addition, the heat source 20 preferably moves at a velocity less than 500 mm/min along the longitudinal direction of the quartz tube 10 (see an arrow of the heat source 20 in FIG. 5b). If the velocity of the heat source 20 is over 500 mm/min, the dehydration gas introduced into the tube may be not sufficiently reacted with the moisture or the hydroxyl groups (OH), thereby not capable of sufficiently removing the moisture or the hydroxyl groups (OH) existing in the soot accumulation layer 41a or the tube 10.

The mechanism by which the dehydration gas is reacted with the moisture or the hydroxyl groups (OH) existing in the soot accumulation layer 41a or the tube 10 for the dehydration reaction may be expressed in the following Reaction Formula 2.

4Si—OH+2Cl₂ [symbol] 2Si—O—Si+4HCl+O₂ Reaction Formula 2

Si—OH—Cl₂ [symbol] Si—O—Si+HCl

2H₂O+Cl₂ [symbol] 2HCl+O₂

After the dehydration process, the quartz tube 10 passes through the sintering processes as shown in FIG. 5c to become a hollow preform in which the clad layer 30 and the base core layer 41 are formed.

In other words, after the dehydration process, while the temperature in the tube 10 is kept over 1700° C. by the heat source 20, which is moved in the direction indicated by an arrow of FIG. 5c, the soot 41a accumulated on the clad layer 30 is sintered and vitrified to form a sintered layer 41b.

At this time, the heat source 20 preferably moves at a velocity less than 500 mm/min along the longitudinal direction of the quartz tube 10 (see an arrow of the heat source 20 in FIG. 5c). If the velocity of the heat source 20 is over 500 mm/min, the particles accumulated on the inner surface of the tube are not uniformly sintered, thereby generating distortion on the deposited surface.

In addition, it is also possible to additionally eliminate residual moisture or hydroxyl group (OH) which is not reacted, by introducing dehydration gases including helium (He), chlorine (Cl₂) and oxygen (O₂) into the tube when executing the sintering process of FIG. 5c.

(2) Forming an Additional Core Layer

After the base core layer 41 is formed on the inner surface of the quartz tube 10 by subsequently executing the processes shown in FIGS. 5a to 5c, at least one additional core layer 42 may be formed on the base care layer 41 by executing the processes shown in FIGS. 5d to 5f repeatedly.

Though only one additional core layer 42 may be formed on the base core layer 41, it is more preferable that at least two additional core layers 42 are formed on the base core layer 41.

This additional core layer is also formed by repeatedly executing the accumulation process (see FIG. 5d), the dehydration process (see FIG. 5e) and the sintering process (see FIG. 5f), similar to the procedure for forming the base core layer 41.

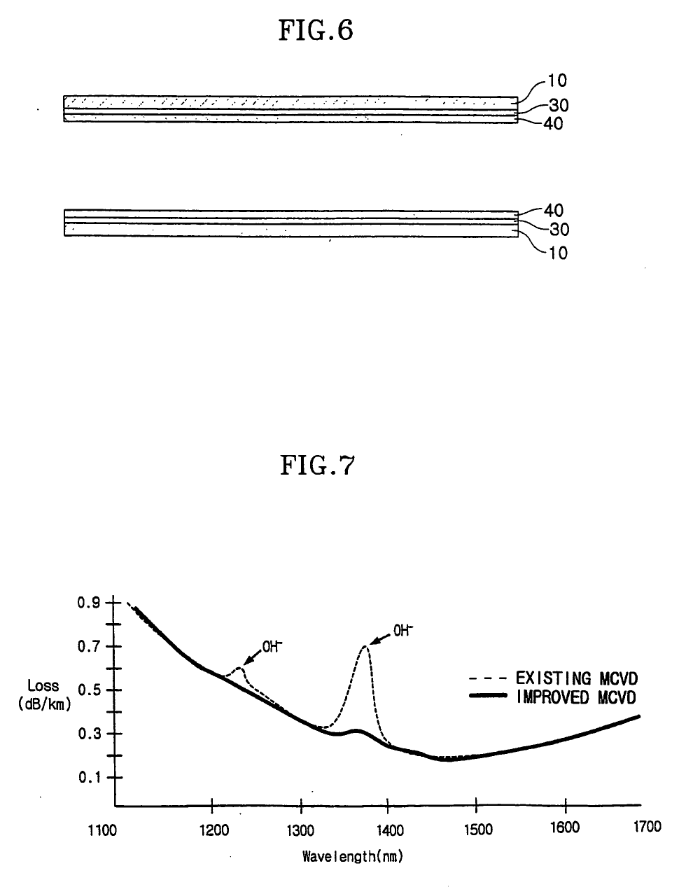

The hollow preform in which the clad layer 30 and the core layer 40 are deposited on the inner surface of the quartz tube 10 as described in FIG. 6 may be made by executing the clad layer forming step, and the core layer forming step in which the accumulation process, the dehydration process and the sintering process are repeated several times.

The hollow preform is then made into an optical fiber preform rod by means of the well-known collapsing step.

The clad layer forming step, the core layer forming step and the collapsing step are successively performed with the use of the same equipment and the same heat source.

In the present invention, the heat source 20 used in the clad layer forming step, the core layer forming step and the collapsing step may be modified variously. For example, various heating means such as an oxygen-hydrogen burner, a plasma torch and an electric resistance furnace may be adopted as the heating source 20.

Since the hydroxyl group (OH) included in the tube and the hydroxyl group (OH) penetrated into the tube due to the oxygen/hydrogen burner may be dispersed into the core layer, it is preferred to deposit the clad layer thick in the clad layer deposition processes in order to prevent the hydroxyl group (OH) from invading into the core layer. For example, an outer diameter ratio of the clad layer and the core layer is preferably over 2.0 after the collapsing step, and a final diameter ratio of the clad layer and the core layer of the optical fiber preform is preferably over 3.0.

At this time, the core layer preferably has a thickness not less than 6.0 mm, the clad layer preferably has a thickness not less than 12.0 mm, and the optical fiber preform preferably has a thickness not less than 20.0 mm.

Also, an optical fiber may be drawn from the optical fiber preform made according to the present invention by means of a common drawing process.

FIG. 7 shows the optical loss of the optical fiber fabricated by the method of the present invention.

FIG. 7 shows the optical loss generated in the optical fiber core in the range of 1100 nm 1700 nm, in which a dotted line shows the optical loss of a conventional optical fiber, and a solid line shows the optical loss of an optical fiber fabricated according to the present invention.

As well known from FIG. 7, in case of the optical fiber made by the method of the present invention, the optical loss caused by hydroxyl group (OH) is dramatically decreased at the wavelength 1385 nm less than 0.33 dB/Km, and the optical losses caused by scattering at the wavelengths 1310 nm and 1550 nm are also decreased respectively less than 0.34 dB/Km and 0.20 dB/Km, compared with the conventional single-mode optical fiber.

Industrial Applicability

The optical fiber preform fabricated according to the method of the present invention has a hydrogen ion concentration less than 1 ppb therein.

Thus, the optical fiber made by using the preform may have an optical loss less than 0.33 dB/Km at the wavelength range of 1340 nm˜1460 nm, which is lower than the optical loss at the wavelength 1310 nm generally used in the optical transmission system.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. A method for fabricating an optical fiber preform substantially without hydroxyl group (OH) in a core layer by use of MCVD (Modified Chemical Vapor Deposition), the method comprising the steps of:
(1) forming a clad layer with a relatively low refractive index by depositing soot containing SiO₂ and GeO₂ on an inner surface of a quartz tube; and
(2) forming a core layer with a relative high refractive index on the clad layer,
wherein the core layer forming step includes:
(a) a base core layer forming step having an accumulation process for generating soot by heating the quartz tube so that a temperature in the quartz tube becomes 1000° C.˜1400° C. while introducing a reaction gas for forming soot together with a carrier gas, and then accumulating the soot on the clad layer, a dehydration process for removing hydroxyl group (OH) and moisture contained in the soot and the tube by heating the quartz tube so that a temperature in the quartz tube becomes 600° C.˜1200° C. while introducing a dehydration gas into the quartz tube, and a sintering process for sintering and vitrifying the soot by heating the quartz tube to which the soot is deposited so that a temperature in the quartz tube becomes over 1700° C.; and
(b) an additional core layer forming step for additionally forming at least one core layer on the base core layer by repeating the accumulation, dehydration and sintering processes of the step (a) at least one time.

2. A method for fabricating an optical fiber preform according to claim 1,
wherein the reaction gas includes SiCl₄ and GeCl₄.

3. A method for fabricating an optical fiber preform according to claim 1,
wherein the accumulation, dehydration and sintering processes are executed successively while the quartz tube is exposed to a moving heat source

4. A method for fabricating an optical fiber preform according to claim 3,
wherein the heat source is selected from the group consisting of an oxygen-hydrogen burner, a plasma torch and an electric resistance furnace.

5. A method for fabricating an optical fiber preform according to claim 4,
wherein the heat source moves at a velocity less than 500 mm/min.

6. A method for fabricating an optical fiber preform according to claim 1,
wherein the dehydration gas is introduced into the quartz tube during the sintering process in order to additionally remove residual moisture and hydroxyl group (OH).

7. A method for fabricating an optical fiber preform according to claim 1,
wherein the dehydration gas includes at least one selected from the group consisting of helium (He), chlorine (Cl₂) and oxygen (O₂).

8. A method for fabricating an optical fiber preform according to claim 1,
wherein the carrier gas is oxygen.

9. A method for fabricating an optical fiber preform according to claim 1,
wherein the quartz tube rotates at a rotation speed of 20˜100 rpm while the soot is accumulated.

10. A method for fabricating an optical fiber preform according to claim 1,
wherein there is formed more than one clad layer on the inner surface of the quartz tube.

11. A method for making a single-mode optical fiber comprising the steps of: forming a preform rod by condensing the optical fiber preform fabricated according to the method defined in claim 1, and then drawing the preform rod to make an optical fiber.
